(19) United States
(12) Patent Application Publication
(10) Pub. No.: US 2007/0248336 A1
(43) Pub. Date: Oct. 25, 2007

(54) Circuit System and Method for Operating an Electric Motor Having Variable Speed From a Direct-Voltage Source

(76) Inventors: Norbert Knab, Appenweier (DE); Karlheinz Lunghard, Buehlertal (GB); Holger Thoelke, Achern (GB)

Correspondence Address: KENYON & KENYON LLP, ONE BROADWAY, NEW YORK, NY, 10004, US

(21) Appl. No.: 11/660,889

(22) PCT Filed: Jun. 23, 2005
(86) PCT No.: PCT/EP05/52929

§ 371 Date: Feb. 22, 2007

(30) Foreign Application Priority Data
Aug. 28, 2004 (DE) 10 2004 041 765.2

(51) Int. Cl. H02P 7/29

(52) U.S. Cl. 388/804

(57) ABSTRACT

A circuit system and a method for operating an electric motor having variable speed from a direct-voltage source is proposed, in particular for operating a cooling air fan motor of a motor vehicle from the vehicle's electrical system. The circuit system uses pulse-width-modulated input signals that are provided by a control unit, and enables, through integration and threshold value comparison of the signals, an operation of the electric motor with different speeds based on differentiated series resistor connection, corresponding to the pulse-duty ratio of the pulse-width-modulated input signals.

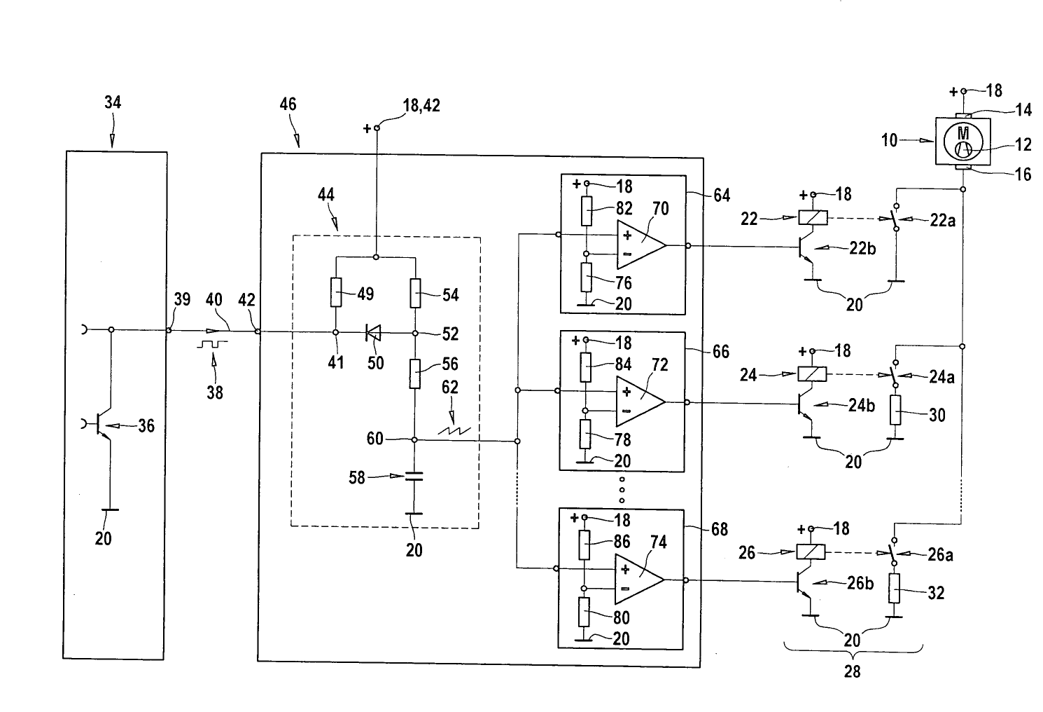

### FIELD OF THE INVENTION

The present invention relates to a circuit system and to a method for operating an electric motor having variable speed from a direct-voltage source, in particular for operating a cooling air fan motor of a motor vehicle from its vehicle electrical system.

### BACKGROUND INFORMATION

Operating systems for electric motors, in particular for brush motors of cooling air fans for motor vehicles, are known in principle, the setting of the speed of the motor taking place either via pulse-width-modulated (PWM) signals and clocked regulators or via switched motor current circuits having different series resistors. The standard design for motor controlling by clocked regulators is to supply the motor voltage using a microcontroller, arbitrarily many operating states of the motor being capable of being realized in this way. In supplying the motor with voltage via different series resistors, switches or relays are used that are controlled directly with a voltage signal and that enable motor operation via separate current circuits having different series resistors, with respectively predetermined speeds. Here, as a rule the desired motor speed is predetermined by thermal switches.

The design using separate motor switching circuits has the advantage of low cost, as long as only approximately two different speed levels are required. In contrast, the clocked controlling of the motor using pulse-width-modulated signals offers many possibilities in the allocation of an advantageous motor speed; however, the technical and economical outlay for such circuit systems is considerable, because due to the complexity of the evaluation of the PWM signals it is generally necessary to use microcontrollers here.

### SUMMARY OF THE INVENTION

The exemplary embodiments and/or exemplary methods of the present invention is directed to providing a technically advantageous and economically favorable possibility for operating an electric motor with different speeds from a direct-voltage source, enabling the selection of a larger number of speed levels using an economical circuit system. This is achieved by the features of the systems described herein, which enable a circuit arrangement and a motor operation using a few discrete constructive elements without a microcontroller.

For the conversion of the pulse-width-modulated input signals of the converter, a simple integration circuit having few components can advantageously be used that is on the one hand connected to a voltage source and on the other hand is connected to the output of the control unit for the electric motor that supplies the pulse-width-modulated signals. Such a device enables the economical provision of a sawtooth-shaped integration signal, corresponding to the pulse and pause times of the pulse-width-modulated output signal of the control unit. A particularly simple circuit system is obtained if the terminal away from ground of a capacitor of the integration device of the converter is connected via an ohmic resistance to its reference voltage source, and is additionally connected via a decoupling diode and a decoupling resistor to the output of the control unit, the output of the control unit being capable of being connected directly to ground via the collector-emitter path of a transistor. Here, the discharge resistor of the capacitor can simultaneously be a part of its charge circuit.

In addition, the circuit system according to the exemplary embodiments and/or exemplary methods of the present invention can advantageously be fashioned in such a way that the terminal away from ground of the capacitor of the integration device of the converter is connected directly to an input of each of a plurality of comparators connected in parallel, whose reference inputs are charged with different threshold value voltages. The outputs of the comparators can then each control a relay via a respective amplifier, for example in the form of a transistor, the switching contacts of each relay being on the one hand connected in parallel to a terminal of the electric motor and on the other hand separated via series resistors, or connected directly to ground. Thus, corresponding to the pulse-duty ratio of the PWM signals at the input of the converter, a current circuit of the electric motor having more or less strong resistance is connected to ground, while the other terminal of the electric motor is connected permanently to the positive pole of the voltage source. Corresponding to the pulse-duty ratio of the PWM signal at the input of the converter, the switching thresholds of a plurality of comparators are exceeded, so that the resulting resistance in the motor current circuit results from the connection in parallel of different series resistors.

Furthermore, it has turned out to be particularly advantageous for the integration device and the various comparators to be connected to the same voltage source. There nonetheless results, for example given voltage fluctuations in the electrical system of a motor vehicle, an unfalsified control signal for the electric motor, because a change in the common supply voltage has the same effect on the level of the integration signal and on the switching threshold of the comparators, so that the motor speed predetermined by the pulse-duty ratio of the PWM input signal is maintained.

Further details and constructions of the exemplary embodiments and/or exemplary methods of the present invention are described herein as to the exemplary embodiments.

### BRIEF DESCRIPTION OF THE DRAWING

The FIGURE depicts a circuit system for operating a cooling air fan motor of a motor vehicle from the vehicle's electrical system.

### DETAILED DESCRIPTION

In the FIGURE, 10 designates an electric motor that is mechanically coupled to a cooling air fan 12 and is supplied via brushes 14, 16 from the electrical system of a motor vehicle. The positive pole of the voltage source is designated 18 and the ground terminal is designated 20. While brush 14 of electric motor 10 is connected permanently to positive pole 18 of the voltage source, brush 16 is connected to ground terminal 20 via a plurality of current circuits that are connected in parallel via relay contacts 22a, 24a, and 26a. Relay contacts 22a, 24a, and 26a are actuated by relays 22, 24, and 26, which are each switched via a respective amplifier 22b, 24b, 26b, each in the form of a transistor. Here, relay contact 22a is connected directly to ground 20, relay contact 24a is connected to ground via a resistor 30 and relay contact 26a is connected to ground via a resistor 32. The resistance values of resistors 30 and 32 can be the same or different. If standard cooling air fan motors connected to the 12-volt electrical system of a motor vehicle are used, these values are in the range from approximately 100 mΩ to approximately 400 mΩ. Given the use of equal resistors 30 and 32, the different speeds of electric motor 10 result from the fact that when the higher switching threshold is achieved at comparator 66, a lower overall resistance results due to the parallel connection of resistor 30 to resistor 32.

The dashed interruption of the current circuit from brush 16 to ground pole 20 is intended to indicate that the drawing merely represents an exemplary embodiment, and that instead of three relays it is also possible to use a larger number of relays, with a larger number of armature current circuits having different resistances.

The target values of the respective motor speed are predetermined by the pulse-duty ratio of the PWM signals at the input of the circuit system according to the exemplary embodiments and/or exemplary methods of the present invention. This circuit system supplies a control unit 34 (shown only schematically in the drawing) having a transistor 36 connected to ground at its output 39, to whose collector the pulse-width-modulated signals (PWM signals) 38 are adjacent for controlling the speed of electric motor 10. Such a transistor functioning as a switch to ground is designated an “open-collector transistor.”

PWM signals 38 then travel via a line 40 to input 42 of integration device 44 of a converter 46. Integration device 44 is adjacent to positive pole 18 of the voltage source, which is connected to input 42 of the integration device via a resistor 49 and a connection point 41. Connection point 41 is simultaneously adjacent to the cathode of a decoupling diode 50, whose anode is connected to a tap 52 between two resistors 54 and 56 in the charge or discharge circuit of capacitor 58. One electrode of capacitor 58 is connected to ground 20, and its other electrode is connected via the two resistors 54 and 56 to the positive pole 18 of the voltage source, or to the anode cf diode 50. At terminal 60 of capacitor 58 oriented away from ground 20 of the voltage source, there then appears a sawtooth signal 62 which is dependent, with respect to its direct voltage portion and its shape, on the pulse-duty ratio of PWM signal 38.

The evaluation of sawtooth signal 62 takes place through a plurality of comparators 64, 66, and 68 that are connected in parallel at the input side, and that at the output side individually control relays 22, 24, and 26 via amplifiers 22b, 24b, and 26b, here in the form of transistors. In principle, comparators 64, 66, and 68 have the same arrangement, each having an operational amplifier 70, 72, and 74, and each having a voltage divider, adjacent on the one hand to positive pole 18 and on the other hand to ground pole 20 of the voltage source, having different divider resistors. If, for example, divider resistors 82, 84, and 86, each adjacent to positive potential 18, each measure 20 kΩ, then divider resistors 76, 78, and 80, each connected to ground 20, could respectively measure 10 kΩ, 5 kΩ, and 3 kΩ, in order to define suitable different switching thresholds at the respective inverting input of operational amplifiers 70, 72, and 74.

The circuit system operates as follows:

At the output of control unit 34, or at the collector of transistor 36, there appear PWM signals 38 whose level changes between the potential of voltage source 18 and ground potential. The pulse-duty ratio of PWM signals 38, i.e., the respective pulse or pause duration, determines the speed of electric motor 10; in the present case, a higher speed of motor 10 is allocated to a longer pulse duration of PWM signal 38. Corresponding to the curve of PWM signals 38, the potential at connecting point 41 of resistor 49 to the cathode of diode 50 also fluctuates between the potential of positive pole 18 of the voltage source and ground. As long as the potential at connecting point 41 corresponds to the potential of the voltage source, capacitor 58 is charged via the series circuit of resistors 54 and 56. The charging process ends when ground potential appears at connecting point 41, and capacitor 58 discharges via partial resistor 56 of its charge circuit and via diode 50, until the positive edge of PWM signal 38 again appears at connecting point 41. At terminal 60 of capacitor 58, there arises a sawtooth-shaped direct voltage whose mean value increases with the pulse-duty ratio of PWM signals 38.

Sawtooth voltage 62, whose level is variable, is now simultaneously adjacent to the inputs of the three comparators 64, 66, and 68; here, only those operational amplifiers 70, 72, 74 switch through whose reference signal at the inverting input is lower than the sawtooth signal 62 at the non-inverting input. This means that given a small pulse-duty ratio of PWM signals 38 at the input of converter 46, or at the input of integration device 44, only the comparator 68 having the lowest threshold voltage corresponding to the ratio of its divider resistors 80 and 86 switches through, thus closing relay contact 26a. Because series resistor 32 in the armature current circuit of electric motor 10 represents the greatest possible series resistance, electric motor 10 now rotates with the lowest speed. As the level of sawtooth voltage 62 increases, comparator 66 also subsequently switches through, and activates, via amplifier 24b, relay 24 in order to close relay contact 24a. The resistance value of the parallel circuit of resistors 30 and 32 is now smaller than that of resistor 32 alone, so that a higher speed results for electric motor 10. Correspondingly, given a further increase in the level of sawtooth signal 62, relay 22 is activated via comparator 64 and amplifier 22b, and relay contact 22a is closed, so that the motor is connected to ground without a series resistor and achieves its maximum speed, independent of whether relay contacts 24a and 26a are closed. On the other hand, relay contacts 22a, 24a, and 26a can also be realized so as to be able to be switched separately, so that when relay 24 responds relay contact 26a is opened, and only series resistor 30 is effective in the motor current circuit. If necessary, intermediate stages for the motor speed can also be created through optional single or parallel switching of the series resistors. In this case, the value of resistor 30 is dimensioned smaller than the value of resistor 32.

The number of three comparators 64, 66, and 68, is selected only as an example. This number, and thus the number of predeterminable speed stages of electric motor 10, can also be selected to be greater; an upper limit in terms of cost results from a comparison of the costs of the circuit according to the exemplary embodiments and/or exemplary methods of the present invention with a clocked regulation using a microcontroller.

In sum, the circuit system according to the exemplary embodiments and/or exemplary methods of the present invention can be characterized in that with a low circuit outlay the information contained in the pulse-duty ratio of PWM signal 38 is economically used to set the speed of the motor via the control value of the motor. Here, from input-side PWM signal 38 output signals are generated directly without using a microcontroller, and in the exemplary embodiment the signals are used to control relays. Instead of relays, of course, it is also possible to use other switching devices, such as for example MOSFETs, in the motor current circuits.

1-10. (canceled)

11. A circuit system for operating an electric motor having variable speed from a direct-voltage source, the circuit system comprising:
a switching device in a supply current circuit of the electric motor; and
a converter to integrate pulse-width-modulated input signals of a control unit, the converter having a plurality of comparators having different switching thresholds, whose outputs are each connected to the electrical switching device, which closes the motor current circuit via breaker gaps having different series resistors.

12. The circuit system of claim 11, wherein an integration device of the converter is coupled to a reference voltage source and is coupled to an output of the control unit for the electric motor that supplies pulse-width-modulated signals.

13. The circuit system of claim 11, wherein an output of the control unit for the electric motor is connectable to ground via a collector-emitter path of an open collector transistor.

14. The circuit system of claim 11, wherein an integration device and the comparators are coupled to a same voltage source.

15. The circuit system of claim 11, wherein a terminal oriented away from a ground of a capacitor of an integration device is coupled in each case to one input of the comparators, and is connected via a decoupling diode and a resistor to an output of the control unit.

16. The circuit system of claim 11, wherein the outputs of the comparators are coupled via amplifiers to relays whose switching contacts are each coupled in parallel to a terminal of the electric motor, and are coupled to ground one of indirectly via series resistors and directly.

17. A method for operating an electric motor having variable speed from a direct-voltage network, the method comprising:
controlling a speed of the electric motor through pulse-width-modulated input signals that are integrated in a converter; and
supplying integrated signals to inputs of a plurality of comparators having different switching thresholds, wherein output signals of the comparators control switching devices having different series resistors for a motor current circuit of the electric motor.

18. The method of claim 17, wherein a reference potential of the comparators is derived from a same voltage source as a supply voltage of an integration device.

19. The method of claim 17, wherein a capacitor of an integration device of the converter is charged corresponding to a pulse-duty ratio of pulse-width-modulated input signals during a high time, and is discharged during a low time via a decoupling diode and via a transistor at an output of the control unit.

20. The method of claim 17, wherein an output signal of an integration device is supplied to inputs, connected in parallel, of the comparators, outputs of the comparators controlling separate supply current circuits of the electric motor having different series resistors, a motor current circuit without a series resistor being allocated to a comparator having a highest switching threshold.

21. The method of claim 17, wherein the electric motor is for operating a cooling air fan motor of a motor vehicle from an electrical system of the vehicle.

22. The circuit system of claim 11, wherein the electric motor is for operating a cooling air fan motor of a motor vehicle from an electrical system of the vehicle.
